(19) United States
(12) Patent Application Publication
(10) Pub. No.: US 2019/0066134 A1
(43) Pub. Date: Feb. 28, 2019

(54) SURVEY SAMPLE SELECTOR FOR EXPOSING DISSATISFIED SERVICE REQUESTS

(71) Applicant: INTERNATIONAL BUSINESS MACHINES CORPORATION, Armonk, NY (US)

(72) Inventors: Chang Sheng Li, Beijing (CN); Feng Li, Beijing (CN); Qi Cheng Li, Beijing (CN); Soumitra Sarkar, Cary, NC (US); Xin Zhou, Beijing (CN)

(21) Appl. No.: 15/690,884

(22) Filed: Aug. 30, 2017

(51) Int. Cl. G06Q 30/02; G06N 5/02; G06N 7/00

(52) U.S. Cl. CPC G06Q 30/0203; G06N 7/005; G06N 5/022

(57) ABSTRACT

Embodiments of the present invention disclose a method, computer program product, and system for exposing more dissatisfied service requests through survey sample selection. The computer builds a user dissatisfaction model based on a plurality of historical survey results, and a plurality of historical service request information. The plurality of historic service request information includes at least one dissatisfaction metric, wherein the at least one dissatisfaction metric includes a total time spent resolving a problem, a total travel time, a total onsite time, a at least one part used, and/or a plurality of other metrics. The computer determines a probability of dissatisfaction for each of a plurality of service requests. The computer selects a survey sample that includes a plurality of dissatisfied users based on the determined probability of dissatisfaction for each of the plurality of service requests. The computer transmits a survey to each user of the survey sample.

### BACKGROUND

The present invention relates generally to the field of machine learning-guided survey sample selection, and more particularly to machine learning-guided survey sample selection for exposing dissatisfied service request fulfillments.

Many companies conduct surveys to assess user satisfaction at a service request level. Requests to customers under a contract (e.g., Citigroup for TSS) to participate in surveys has to be limited to avoid “fatigue”. Therefore, the use of analytics to predict survey results without conducting surveys, by analyzing historical survey results, would be very useful. However, most service requests under surveys are evaluated as satisfied, so the use of a machine learning-based analytical method to accurately predict the minority class of dissatisfied fulfillment of service requests and dissatisfied users can be a challenging task.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for exposing more dissatisfied service requests through survey sample selection. The computer builds a user dissatisfaction prediction model based on a plurality of historical survey results, and a plurality of historical service request information. The plurality of historic service request information includes at least one service request fulfillment related metric, wherein the at least one metric includes a total time spent resolving a problem, a total travel time, a total onsite time, a at least one part used, and/or a plurality of other metrics. The computer determines a probability of dissatisfaction for each of a plurality of service requests. The computer selects a survey sample that includes a plurality of dissatisfied users based on the determined probability of dissatisfaction for each of the plurality of service requests. The computer transmits a survey to each user of the survey sample.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram illustrating the system for exposing more dissatisfied service request fulfillments through survey sample selection, in accordance with an embodiment of the present invention.

FIG. 2 is a flowchart depicting operational steps to select a survey sample for exposing more dissatisfied service request fulfillments of FIG. 1, in accordance with an embodiment of the present invention.

FIG. 3 is a flowchart depicting operational steps to select a survey sample for exposing more dissatisfied service request fulfillments, using a previously created user dissatisfaction prediction model of FIG. 1, in accordance with an embodiment of the present invention.

FIG. 4 is a block diagram of components of a computing device of the system for exposing more dissatisfied service request fulfillments through survey sample selection of FIG. 1, in accordance with embodiments of the present invention.

FIG. 5 depicts a cloud computing environment according to an embodiment of the present invention.

FIG. 6 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout.

Embodiments of the invention are generally directed to a system for generating a sample of service requests to survey that has a greater number of dissatisfied people who submitted those requests. Historical survey results and historical service request information is gathered as training data. A service request is a request raised by a user for resolving an issue, problem, ticket, and/or any other such request. Service metrics are indicators to measure service providers' service performance, for example, total time spent on resolving the issue, total travel time, total onsite time, part used, and/or other such metrics. The historical survey results and the historical service request information are processed to construct a dissatisfaction prediction model. The dissatisfaction prediction model is based on features that are selected from the service metrics that result in the most accurate prediction model. Using the dissatisfaction prediction model, the probability of dissatisfaction is predicted for recent service requests made by users. A survey sample is selected to be biased in favor of the probability of user dissatisfaction. The survey sample that has a bias toward dissatisfied users is then sent to the original service requesters to complete in order to get a higher number of survey responses where the customer reports being dissatisfied.

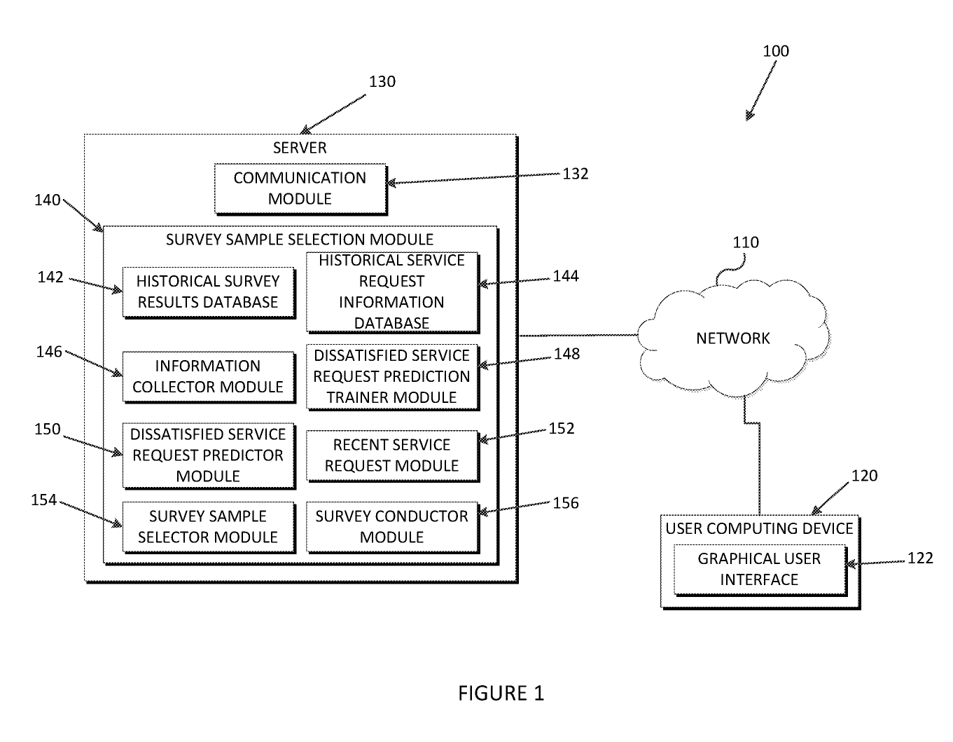

FIG. 1 is a functional block diagram illustrating a system for exposing more dissatisfied service request fulfillments through survey sample selection 100, in accordance with an embodiment of the present invention.

The system for exposing more dissatisfied service request fulfillments through survey sample selection 100 includes a user computing device 120 and a server 130. The user computing device 120 and the server 130 are able to communicate with each other, via a network 110.

The network 110 can be, for example, a local area network (LAN), a wide area network (WAN) such as the Internet, or a combination of the two, and can include wired, wireless, or fiber optic connections. In general, the network 110 can be any combination of connections and protocols that will support communications between the user computing device 120 and the server 130, in accordance with one or more embodiments of the invention.

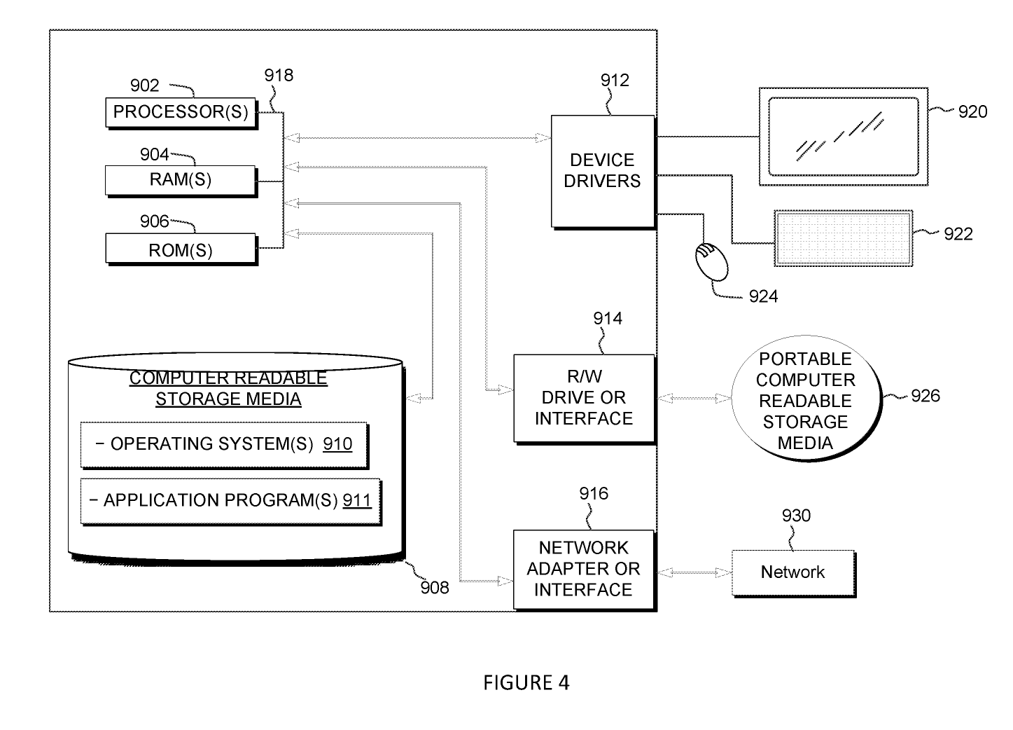

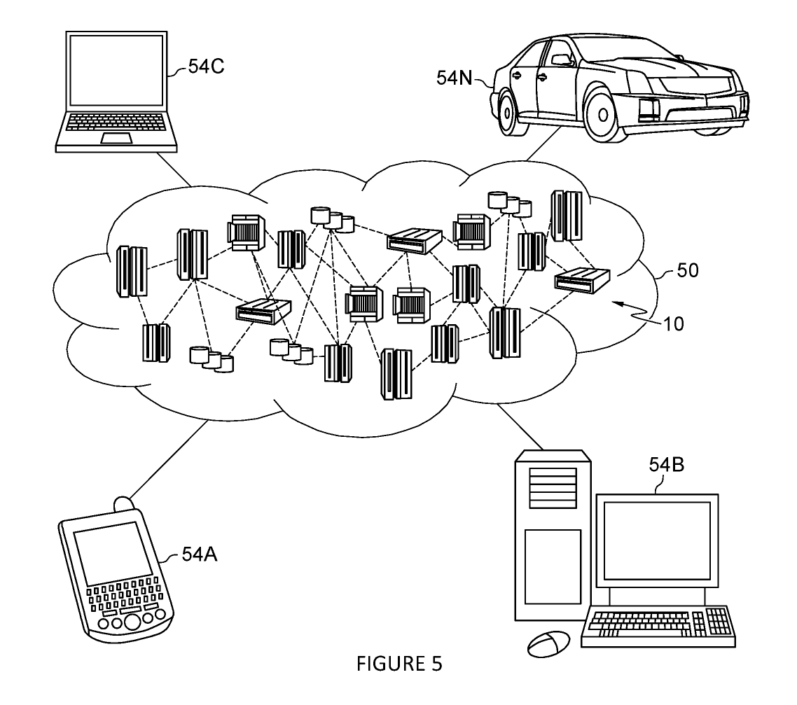

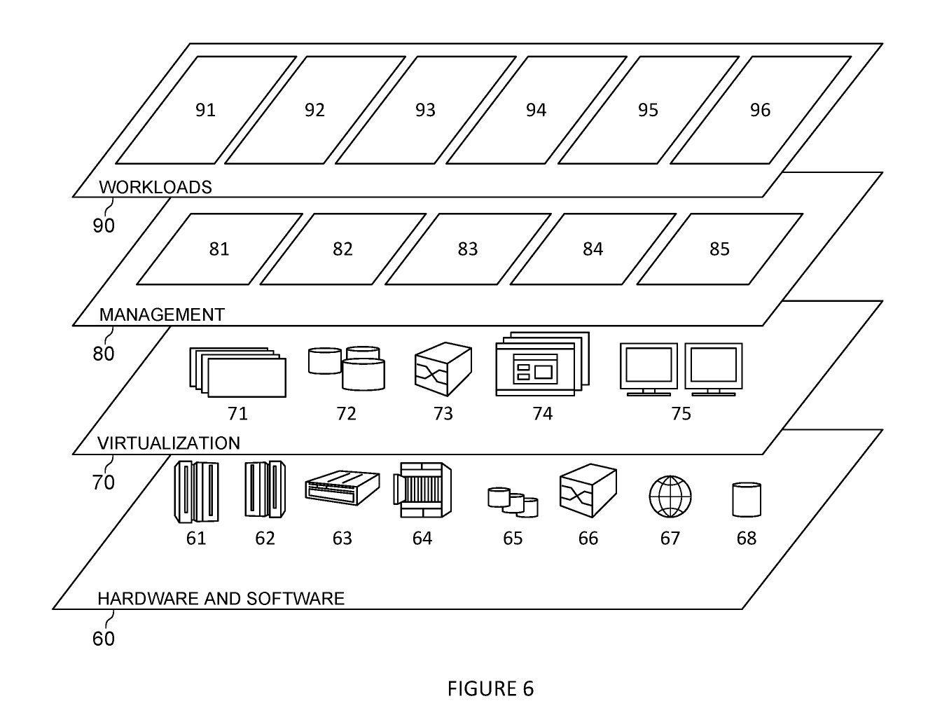

The user computing device 120 may be any type of computing device that is capable of connecting to the network 110, for example, a laptop computer, tablet computer, netbook computer, personal computer (PC), a desktop computer, a smart phone, or any programmable electronic device supporting the functionality required by one or more embodiments of the invention. The user computing device 120 may include internal and external hardware components, as described in further detail below with respect to FIG. 4. In other embodiments, the user computing device 120 may operate in a cloud computing environment, as described in further detail below with respect to FIG. 5 and FIG. 6.

The user computing device 120 represent a computing device that include a user interface, for example, a graphical user interface 122. The graphical user interface 122 can be any type of application that contains the interface necessary to receive a survey from a survey conductor module 156.

The server 130 includes a communication module 132 and a survey sample selection module 140. The server 130 is able to communicate with the user computing device 120, via the network 110. The server 130 may include internal and external hardware components, as depicted, and described in further detail below with reference to FIG. 4. In other embodiments, the server 130 may include internal and external hardware components, as depicted, and described in further detail below with respect to FIG. 5, and operate in a cloud computing environment, as depicted in FIG. 6.

The communication module 132 is capable of transmitting a survey from the survey conductor module 156 to the user computing device 120 to be displayed by the graphical user interface 122.

The survey sample selection module 140 includes a historical survey results database 142, a historical service request information database 144, an information collector module 146, a dissatisfied service request prediction trainer module 148, a dissatisfied service request predictor module 150, a recent service request module 152, a survey sample selector module 154, and the survey conductor module 156.

The historical survey results database 142 and the historical service request information database 144 are data stores that store previously obtained data. The historical survey results database 142 contains the results of previously administered user surveys. The historical service request information database 144 contains historical service requests and historical service metrics. The historical service requests are previous requests made by users for resolving issues, problems, tickets, or any other such request. The historical service metrics are indicators for measuring the service providers' service performance, for example, total time spent on resolving the problem, total travel time, total onsite time, parts used, and/or other such metrics. The historical survey results database 142 and the historical service request information database 144 transmit their contents to the information collector module 146 as training data.

The information collector module 146 retrieves training data from the historical survey results database 142 and the historical service request information database 144. The information collector module 146 processes the training data and transmits the training data to the dissatisfied service request prediction trainer module 148.

The dissatisfied service request predication trainer module 148 retrieves the processed training data from the information collector module 146 to build a user dissatisfaction model to determine the probability of a dissatisfied user given a service request. The dissatisfied service request prediction trainer module 148 selects features from the historical service request metrics which can result in the most accurate dissatisfaction prediction model. The dissatisfaction features could also be selected by an administrator. The dissatisfied service request predication trainer module 148 selects a classification approach, such as, logistic regression, stepwise logistic regression, random forest, and/or any other such approach, to determine the importance of each metric. The metrics are then sorted based on how well they can predict dissatisfied users. The metrics that can help the model predict dissatisfaction most accurately are selected for use in the model. The selected metrics and the complex statistical relationships between them for highest prediction accuracy are learnt based on the training data. The dissatisfied service request prediction trainer module 148 uses a logistic regression model and learns a function of the input features, a subset of the service request metrics used in the model. Multiple dissatisfaction models can be made by using different classification approaches for selecting metrics that show dissatisfaction. When multiple dissatisfaction models are trained, the results of each are combined to form one dissatisfaction model. The dissatisfied service request prediction trainer module 148 creates the dissatisfaction model using an iterative training and testing process, which includes the selected metrics as its input parameters. The dissatisfied service request predictor module 150 is the final trained model produced by the service request prediction trainer module. The dissatisfied service request predictor module 150 is used by the recent service request module 152 for selecting service requests.

The dissatisfied service request predictor module 150 retrieves the dissatisfaction model from the dissatisfied service request prediction trainer module 148. The dissatisfied service request predictor module 150 retrieves recent service requests from the recent service request module 152. The dissatisfied service request predictor module 150 determines the probability of dissatisfaction of the service requests by executing the dissatisfaction prediction model with recent service requests as inputs. The dissatisfied service request predictor module 150 determines the probability of service requests that would correspond to dissatisfied users. The dissatisfied service request predictor module 150 transmits the determined probability of dissatisfied users to the survey sample selector module 154.

The recent service request module 152 contains service requests where the user has not been surveyed. The recent service request module 152 transmits the service requests to the dissatisfied service request predictor module 150 for determining the probability of dissatisfaction in each service request. The service provider continuously updates the recent service request module 152 with recent service requests of users who have not been surveyed.

The survey sample selector module 154 retrieves the determined probability of dissatisfied users from the dissatisfied service request predictor module 150. The survey sample selector module 154 determines the survey sample based on the determined probability of which service requests have dissatisfied users. The survey sample selector module 154 selects a biased survey sample to favor user dissatisfaction. The survey sample selector module 154 transmits the biased survey sample to the survey conductor module 156.

The survey conductor module 156 retrieves the biased survey sample from the survey sample selector module 154. The survey conductor module 156 transmits a survey to the use computing device 120 of each user in the survey sample to be displayed by the graphical user interface 122, via the communication module 132.

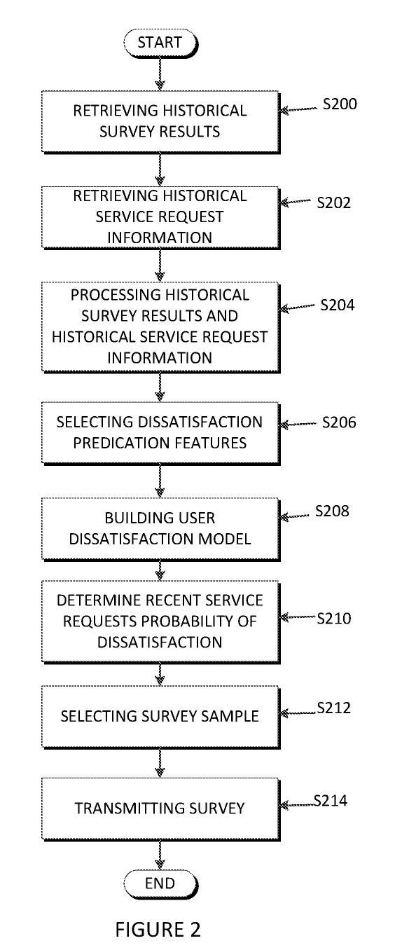

FIG. 2 represents the survey sample selection module 140 selecting a survey sample for exposing dissatisfied service request fulfillments.

FIG. 2 illustrates the survey sample selection module 140 predicting a survey sample that would result in exposing more service requests resulting in dissatisfied users than is possible using a random survey sample selection process. The information collector module 146 retrieves the historical survey results from the historical survey results database 142 (S200). The information collector module 146 retrieves the historical service request information from the historical service request information database 144 (S202). The information collector module 146 processes the historical survey results and the historical service request information (S204). The dissatisfied service request prediction trainer module 148 selects the dissatisfaction-critical metrics from the historical service metrics (S206). The dissatisfied service request prediction trainer module 148 builds the user dissatisfaction prediction model based on the training data (S208). The dissatisfied service request predictor module 150 determines the probability of dissatisfaction for recent service requests (S210). The survey sample selector module 154 selects the survey sample based on the predicted degree of dissatisfaction for each of the service requests (S212). The survey conductor module 156 transmits the survey for the user computing device 120 of each of the users in the survey sample (S214).

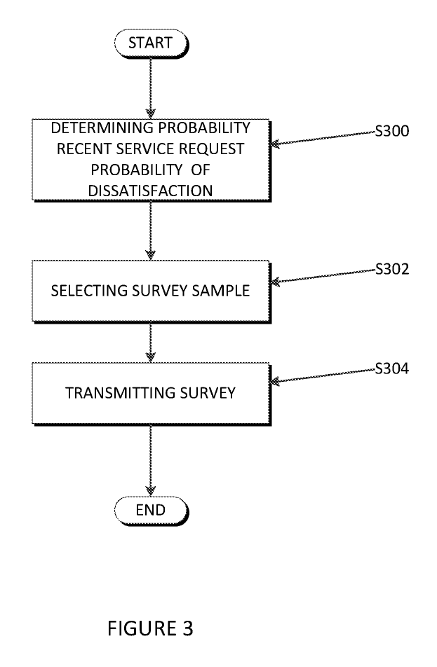

FIG. 3 is a flowchart depicting operational steps to select a survey sample for exposing more dissatisfied service request fulfillments, using a previously created user dissatisfaction prediction model of FIG. 1, in accordance with an embodiment of the present invention. The dissatisfied service request predictor module 150 determines the probability of dissatisfaction for recent service requests (S300). The survey sample selector module 154 selects the survey sample based on the predicted degree of dissatisfaction for each of the service requests (S302). The survey conductor module 156 transmits the survey for the user computing device 120 of each of the users in the survey sample (S304).

FIG. 4 depicts a block diagram of components of the user computing device 120 and/or the server 130 of the system for exposing more dissatisfied service request fulfillments through survey sample selection 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

The user computing device 120 and/or the server 130 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, survey sample selection module 140 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The user computing device 120 and/or the server 130 may also include a R/W drive or interface 914 to read from and write to one or more portable computer readable storage media 926. Application programs 911 on the user computing device 120 and/or the server 130 may be stored on one or more of the portable computer readable storage media 926, read via the respective R/W drive or interface 914 and loaded into the respective computer readable storage media 908.

The user computing device 120 and/or the server 130 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the user computing device 120 and/or the server 130 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The user computing device 120 and/or the server 130 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the survey sample selection module 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method for exposing more dissatisfied service request fulfillments through survey sample selection, the method comprising:
building, by a computer, a user dissatisfaction prediction model based on a plurality of historical survey results, and a plurality of historical service request information, wherein each of the plurality of historic service request information includes at least one service request fulfillment metric, wherein the at least one service request fulfillment metric includes at least one of a total time spent resolving a problem, a total travel time, a total onsite time, an at least one part used, and/or a plurality of other metrics;
determining, by the computer, a probability of dissatisfaction for each of a plurality of service requests, wherein the probability of dissatisfaction is based on the user dissatisfaction prediction model;
selecting, by the computer, a survey sample that includes a plurality of dissatisfied users based on the determined probability of dissatisfaction for each of the plurality of service requests; and
transmitting, by the computer, a survey to each user of the survey sample.

2. The method of claim 1, wherein building a user dissatisfaction model further comprises:
retrieving, by the computer, the plurality of historical survey results from a historical survey result database; and
retrieving, by the computer, the plurality of historical service request information from a historical service request information database, wherein each of the plurality of historical service request information includes a plurality of service metrics, wherein at least one of the plurality of service metrics is the at least one service request fulfillment metric.

3. The method of claim 2, wherein building a user dissatisfaction model further comprises:
selecting, by the computer, a classification approach to determine the probability of dissatisfaction of the plurality of service metrics, wherein the selected classification approach is selected from a group of a logistic regression, a stepwise logistic regression, a random forest, or any other approach; and
classifying, by the computer, the plurality of service metrics using the classification approach to determine a probability for each of the plurality of service metrics being a dissatisfaction metric.

4. The method of claim 3, wherein building a user dissatisfaction prediction model further comprises:
assigning, by the computer, a value to each of the plurality of classified service metrics based on the classification approach; and
determining, by the computer, a plurality of dissatisfaction metrics by designating that the plurality of classified service metrics based on assigned value for each of the plurality of classified service metrics, respectively, as being a dissatisfaction metric, respectively.

5. The method of claim 4, wherein building a user dissatisfaction model further comprises:
selecting, by the computer, the at least one dissatisfaction metric from the plurality of determined dissatisfaction metrics to be used in the user dissatisfaction model.

6. The method of claim 2, wherein building a user dissatisfaction model further comprises:
selecting, by the computer, a plurality of classification approaches to determine the probability of dissatisfaction of the plurality of service metrics, wherein the selected plurality of classification approaches is selected from a group of a logistic regression, a stepwise logistic regression, a random forest, and/or any other approach; and
classifying, by the computer, the plurality of service metrics using the plurality of selected classification approaches to determine a probability for each of the plurality of service metrics being a dissatisfaction metric.

7. The method of claim 6, wherein building a user dissatisfaction model further comprises:
assigning, by the computer, a value to each of the plurality of classified service metrics based on the classification approach; and
determining, by the computer, a plurality of dissatisfaction metrics by designating that the plurality of classified service metrics based on assigned value for each of the plurality of classified service metrics, respectively.

8. The method of claim 7, wherein building a user dissatisfaction model further comprises:
combining, by the computer, a plurality of results from each of the plurality of selected classification approaches.

9. The method of claim 8, wherein building a user dissatisfaction model further comprises:
selecting, by the computer, the at least one dissatisfaction metric from the combined plurality of results to be used in the user dissatisfaction model.

10. A computer program product for exposing more dissatisfied service request fulfillments through survey sample selection, the computer program product comprising:
one or more non-transitory computer-readable storage media and program instructions stored on the one or more non-transitory computer-readable storage media, the program instructions comprising:
building a user dissatisfaction prediction model based on a plurality of historical survey results, and a plurality of historical service request information, wherein each of the plurality of historic service request information includes at least one service request fulfillment metric, wherein the at least one service request fulfillment metric includes at least one of a total time spent resolving a problem, a total travel time, a total onsite time, an at least one part used, and/or a plurality of other metrics;
determining a probability of dissatisfaction for each of a plurality of service requests, wherein the probability of dissatisfaction is based on the user dissatisfaction prediction model;
selecting a survey sample that includes a plurality of dissatisfied users based on the determined probability of dissatisfaction for each of the plurality of service requests; and
transmitting a survey to each user of the survey sample.

11. The non-transitory computer program product of claim 10, further comprises:
retrieving the plurality of historical survey results from a historical survey result database; and
retrieving the plurality of historical service request information from a historical service request information database, wherein each of the plurality of historical service request information includes a plurality of service metrics, wherein at least one of the plurality of service metrics is the at least one service request fulfillment metric.

12. The non-transitory computer program product of claim 11, further comprises:
selecting a classification approach to determine the probability of dissatisfaction of the plurality of service metrics, wherein the selected classification approach is selected from a group of a logistic regression, a stepwise logistic regression, a random forest, or any other approach; and
classifying the plurality of service metrics using the classification approach to determine a probability for each of the plurality of service metrics being a dissatisfaction metric.

13. The non-transitory computer program product of claim 12, further comprises:
assigning a value to each of the plurality of classified service metrics based on the classification approach; and
determining a plurality of dissatisfaction metrics by designating that the plurality of classified service metrics based on assigned value for each of the plurality of classified service metrics, respectively, as being a dissatisfaction metric, respectively; and
selecting the at least one dissatisfaction metric from the plurality of determined dissatisfaction metrics to be used in the user dissatisfaction model.

14. The non-transitory computer program product of claim 11, further comprises:
selecting a plurality of classification approaches to determine the probability of dissatisfaction of the plurality of service metrics, wherein the selected plurality of classification approaches is selected from a group of a logistic regression, a stepwise logistic regression, a random forest, and/or any other approach; and
classifying the plurality of service metrics using the plurality of selected classification approaches to determine a probability for each of the plurality of service metrics being a dissatisfaction metric.

15. The non-transitory computer program product of claim 14, further comprises:
assigning a value to each of the plurality of classified service metrics based on the classification approach; and
determining a plurality of dissatisfaction metrics by designating that the plurality of classified service metrics based on assigned value for each of the plurality of classified service metrics, respectively;
combining a plurality of results from each of the plurality of selected classification approaches; and
selecting the at least one dissatisfaction metric from the combined plurality of results to be used in the user dissatisfaction model.

16. A computer system for exposing more dissatisfied service request fulfillments through survey sample selection, the computer system comprising:
one or more computer processors, one or more computer-readable storage media, and program instructions stored on one or more of the computer-readable storage media for execution by at least one of the one or more processors, the program instructions comprising:
building a user dissatisfaction prediction model based on a plurality of historical survey results, and a plurality of historical service request information, wherein each of the plurality of historic service request information includes at least one service request fulfillment metric, wherein the at least one service request fulfillment metric includes at least one a total time spent resolving a problem, a total travel time, a total onsite time, an at least one part used, and/or a plurality of other metrics;
determining a probability of dissatisfaction for each of a plurality of service requests, wherein the probability of dissatisfaction is based on the user dissatisfaction prediction model;
selecting a survey sample that includes a plurality of dissatisfied users based on the determined probability of dissatisfaction for each of the plurality of service requests; and
transmitting a survey to each user of the survey sample.

17. The computer system of claim 16, further comprises:
selecting a classification approach to determine the probability of dissatisfaction of the plurality of service metrics, wherein the selected classification approach is selected from a group of a logistic regression, a stepwise logistic regression, a random forest, or any other approach; and
classifying the plurality of service metrics using the classification approach to determine a probability for each of the plurality of service metrics being a dissatisfaction metric.

18. The computer system of claim 17, further comprises:
assigning a value to each of the plurality of classified service metrics based on the classification approach; and
determining a plurality of dissatisfaction metrics by designating that the plurality of classified service metrics based on assigned value for each of the plurality of classified service metrics, respectively, as being a dissatisfaction metric, respectively; and
selecting the at least one dissatisfaction metric from the plurality of determined dissatisfaction metrics to be used in the user dissatisfaction model

19. The computer system of claim 16, further comprises:
selecting a plurality of classification approaches to determine the probability of dissatisfaction of the plurality of service metrics, wherein the selected plurality of classification approaches is selected from a group of a logistic regression, a stepwise logistic regression, a random forest, and/or any other approach; and
classifying the plurality of service metrics using the plurality of selected classification approaches to determine a probability for each of the plurality of service metrics being a dissatisfaction metric.

20. The computer system of claim 19, further comprises:
assigning a value to each of the plurality of classified service metrics based on the classification approach; and
determining a plurality of dissatisfaction metrics by designating that the plurality of classified service metrics based on assigned value for each of the plurality of classified service metrics, respectively;
combining a plurality of results from each of the plurality of selected classification approaches; and
selecting the at least one dissatisfaction metric from the combined plurality of results to be used in the user dissatisfaction model.
